(19) United States
(12) Patent Application Publication
(10) Pub. No.: US 2019/0163868 A1
(43) Pub. Date: May 30, 2019

(54) DESIGN AUTOMATION OF CUSTOMIZED EARTH MOVING BUCKET

(71) Applicant: Caterpillar Inc., Peoria, IL (US)

(72) Inventors: Prashant M. Gokule, Bengaluru (IN); Ashok Rajendran, Chennai (IN); Gopi Duraisamy, Chennai (IN); Rajkishen Paneer, Chennai (IN); Davida Ray Reang, Chennai (IN); Babu M. Kondai, Chennai (IN); Krishna Prasad Konda Rajaram, Chennai (IN); Ashwani Verma, Bengaluru (IN)

(73) Assignee: Caterpillar Inc., Peoria, IL (US)

(21) Appl. No.: 15/823,038

(22) Filed: Nov. 27, 2017

(51) Int. Cl. G06F 17/50

(52) U.S. Cl. CPC G06F 17/5095; G06F 2217/12; G06F 2217/02

(57) ABSTRACT

A method for creating a customized bucket model is provided. The method includes receiving, by a controller, a plurality of inputs from a user, the plurality of inputs associated with the bucket model. The method also includes dynamically generating, by the controller, the bucket model based on the plurality of inputs.

### TECHNICAL FIELD

The present disclosure relates to a system and a method for modeling, and more specifically, to the system and the method for creating a model of a customized bucket.

### BACKGROUND

Machines, such as wheel loaders and excavators, include buckets. In modelling software, such a CREO, a process for generating a bucket model of such buckets involves a manual process. Further, lead time in generating the bucket may be approximately between 40 and 62 hours. The current processes are hence lengthy and laborious, and rely on competency and expertise of a user of the system in creating the bucket model. Due to the manual nature of the process, the process may also be prone to human error.

U.S. Pat. No. 5,197,120 describes a method for generating a parametric design on a computer without the use of a programming language. A drawing processor is used to create a master drawing from which other drawings of different dimensions can then be synthesized by modification of the master drawing. The system merges design values with data from both a design plan and a master drawing to create a finished drawing. In executing a parametric design, a user selects a controlling design plan to be used as a basis of the design. Images of associated master drawings are modified and/or combined to represent the design. The final design is represented by electronically stored data which can be utilized to create a visual display such as a drawing and/or directly to manufacture a part, structure, etc.

### SUMMARY OF THE DISCLOSURE

In one aspect of the present disclosure, a method for creating a customized bucket model is provided. The method includes receiving, by a controller, a plurality of inputs from a user, the plurality of inputs associated with the bucket model. The method also includes dynamically generating, by the controller, the bucket model based on the plurality of inputs.

In another aspect of the present disclosure, a method for creating a customized bucket model is provided. The method includes receiving, by a controller, a plurality of inputs from a user indicative of linkage type, bite width, durability, capacity, and number of teeth associated with a bucket. The method receiving, by a controller, a tolerance range associated with the bite width. The method includes searching, by the controller, a plurality of data sources based on the plurality of inputs and the tolerance range. The method includes reusing, by the controller, one or more parts of a subassembly of the bucket for creating the bucket model if a match is found based on the search. The method includes automatically generating, by the controller, one or more parts of a subassembly of the bucket using a predetermined relationship between parts of the subassembly if the match is not found based on the search. The predetermined relationship includes a correlation of dimensions of parts of the subassembly that lie within the tolerance range and the plurality of user inputs. The method includes generating, by the controller, the bucket model based on the reuse parts and the generated parts.

In yet another aspect of the present disclosure, a method for creating a customized bucket model is provided. The method includes receiving, by a controller, a plurality of inputs from a user, the plurality of inputs including a volume of a bucket to be formed, a machine identification code, an interface type, and a width of the bucket. The method includes creating, by the controller, a heap volume of the bucket model based on the plurality of inputs and a predetermined relationship. The method includes modifying, by the controller, a plurality of sketches associated with multiple parts of the bucket. The modification includes any one of growing or shrinking the plurality of sketches related to a set of master models and driving changes in dimensions of the multiple parts in the set of master models. The method includes generating, by the controller, the bucket model based on the changes in the dimensions of the multiple parts in the set of the master models.

Other features and aspects of this disclosure will be apparent from the following description and the accompanying drawings.

### BRIEF DESCRIPTION OF THE DRAWINGS

FIG. 1 is a side view of an exemplary machine, in accordance with the concepts of the present disclosure;

FIG. 2 is a flowchart of a method for creating a customized bucket model, in accordance with the concepts of the present disclosure;

FIG. 3 is a block diagram of a control system for creating the customized bucket, in accordance with the concepts of the present disclosure;

FIG. 4 is a flowchart of a method for creating the customized bucket model for the machine of FIG. 1, in accordance with the concepts of the present disclosure;

FIGS. 5 and 6 are exemplary user interfaces for creating the customized bucket model, in accordance with the concepts of the present disclosure;

FIG. 7 is a flowchart of another method for creating another customized bucket model, in accordance with the concepts of the present disclosure; and

FIGS. 8 and 9 are exemplary user interfaces for creating the other customized bucket model, in accordance with the concepts of the present disclosure.

### DETAILED DESCRIPTION

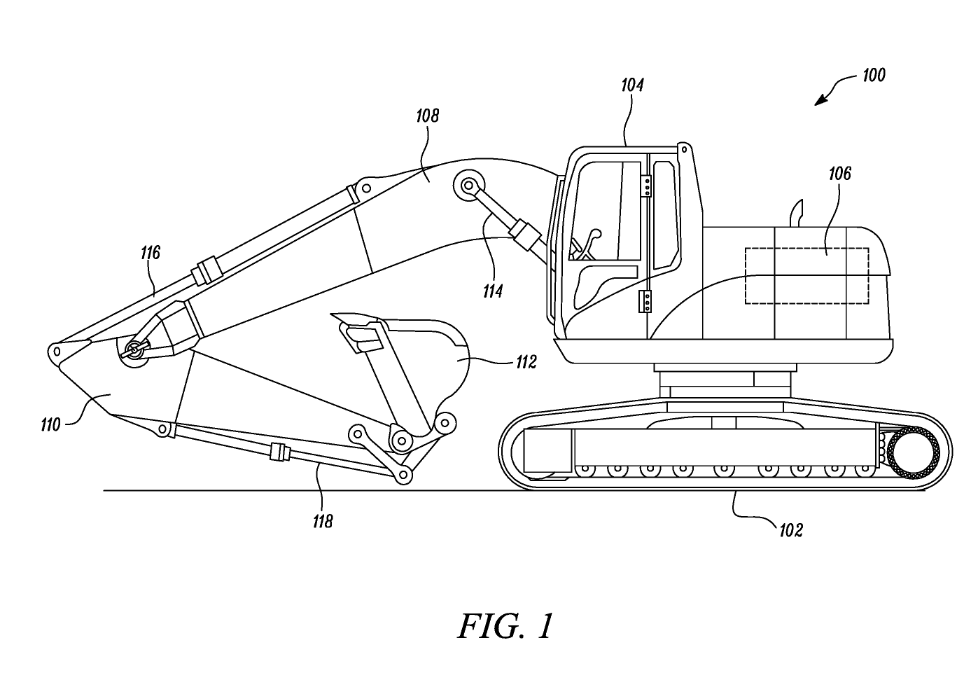

Referring to FIG. 1, an exemplary machine 100 is illustrated. The machine 100 is an excavator. The machine 100 is self-propelled and movable upon tracks 102. An operator cab 104 and a diesel engine 106 or the like are mounted above the tracks 102 and rotatable with respect to the tracks 102. A boom 108 is mounted on the machine 100 rotating with the cab 104. A stick 110 is mounted at the end of the boom 108 and in turn supports a bucket 112. The diesel engine 106 drives a hydraulic pump (not shown) in an engine compartment which supplies high pressure hydraulic fluid to a hydraulic system. The hydraulic system is used to actuate a boom cylinder 114, a stick cylinder 116, and an implement cylinder 118. The machine 100 additionally includes other components that are not described herein.

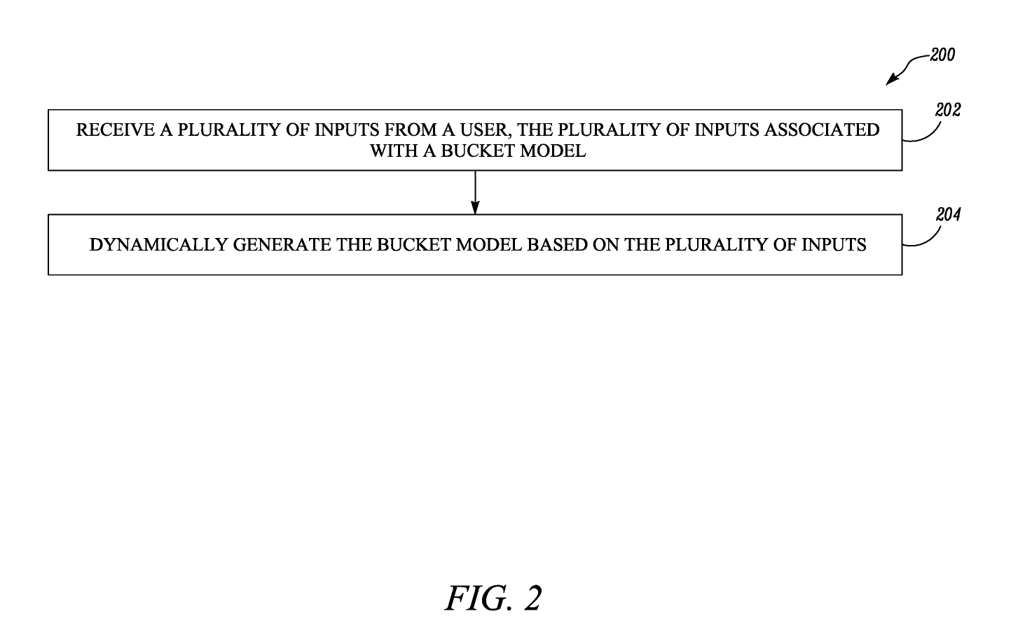

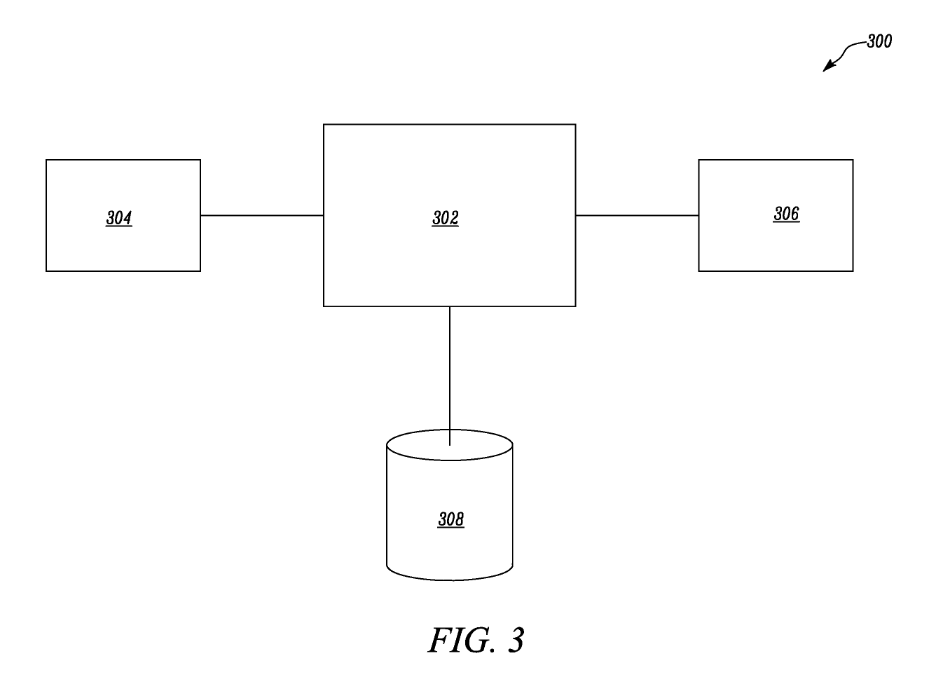

The present disclosure provides a control system 300 (see FIG. 3) and a method 200 (see FIG. 2) for creating a customized bucket model for the bucket 112 of the machine 100. Referring to FIGS. 2 and 3, at step 202, a controller 302 of the control system receives a number of inputs from a user. The inputs are associated with the bucket model to be formed. It should be noted that the term ‘bucket model’ used herein refers to a three-dimensional model of the bucket. At step 204, the controller 302, dynamically generates the bucket model based on the inputs. The bucket model is generated in less than 3 hours. In one example, the bucket model is generated within 30 minutes. The controller 302 is configured to create the bucket model in a CAD software, for example, CREO. The components of the control system 300 and working thereof to generate the customized bucket model will now be described in detail.

Referring to FIG. 3, the control system 300 includes the controller 302. An input device 304 is coupled to the controller 302. The input device 304 may be a monitor, a control panel, a touch screen, or any other input device 304 that the user may use to interact with the system for entering the user inputs. The controller 302 receives the inputs associated with the bucket model through the input device 304.

The controller 302 is coupled to an output device 306. The output device 306 includes a monitor, screen or any other known output device 306 for displaying the bucket model generated by the controller 302. A person of ordinary skill in the art will appreciate that the user may interact with a single tool formed by the control system 300 to generate the bucket model. The input and output device functionalities may be provided by a single hardware interface of the system.

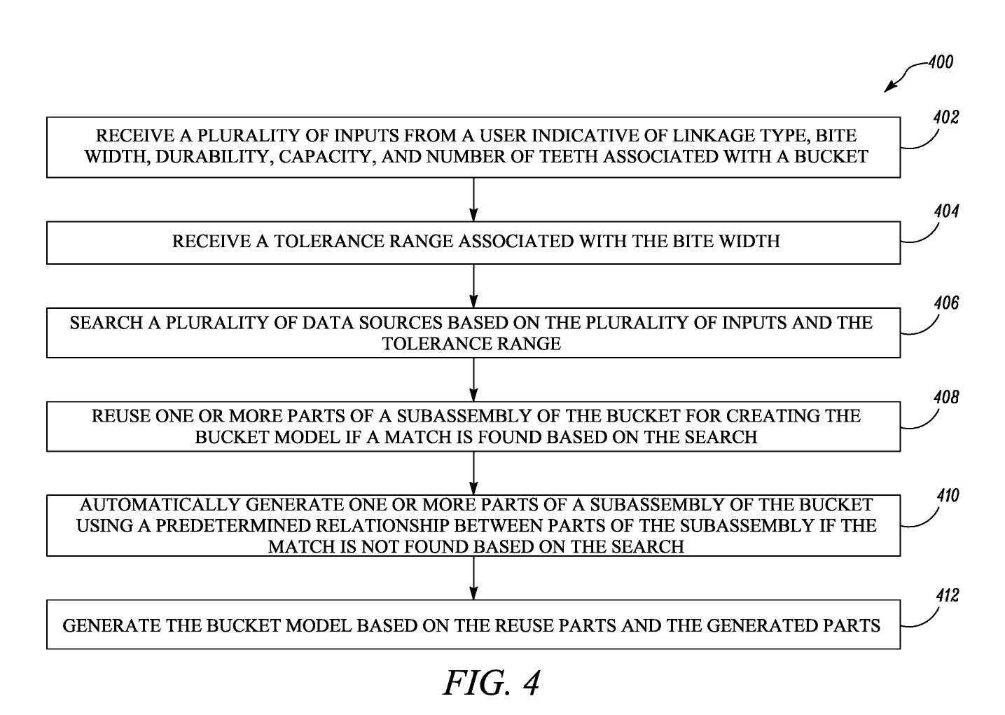

FIG. 4 outlines details of a method 400 used by the control system 300 for generating the customized bucket model for the bucket 112 of the machine 100. As shown in FIG. 3, the controller 302 is also coupled to a database 308. The database 308 stores data related to pre-drawn bucket models. Initially, the controller 302 is configured to merge data associated with a number of different buckets from various of data sources to form the various data entries stored in the database 308. The data sources may be online or offline data repositories that store information related to multiple buckets. The data includes dimensional data, part numbers associated with the buckets and/or information related to how the parts join to form the bucket.

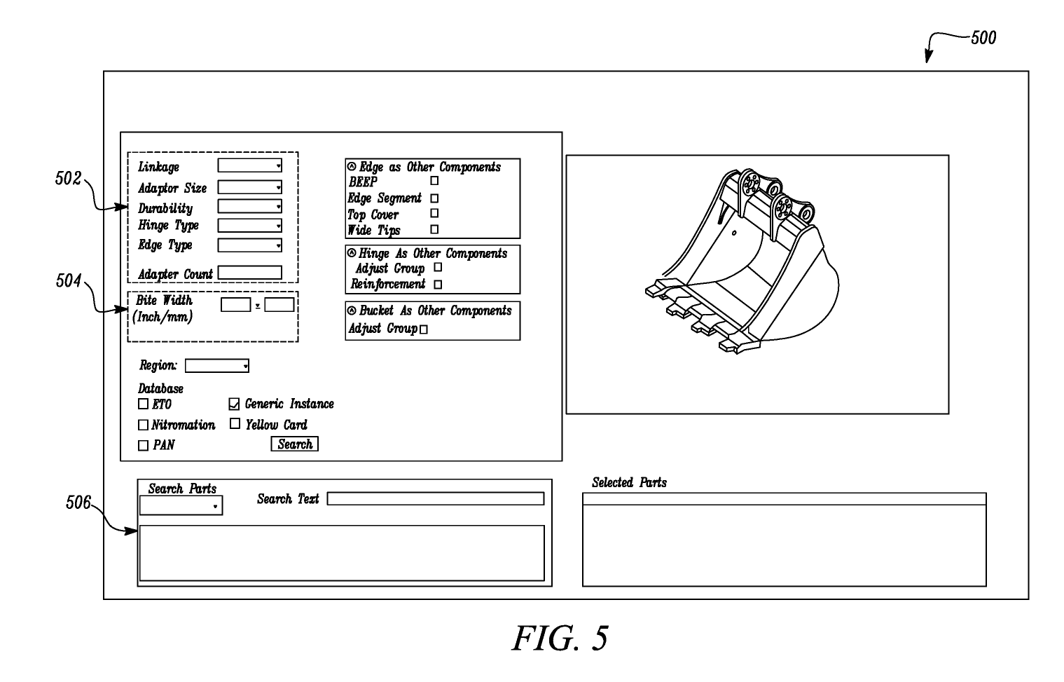

At step 402, the controller 302 receives the inputs from the user through the input device 304. The inputs are indicative of linkage type, bite width, durability, capacity, and number of teeth associated with the bucket model to be formed by the control system 300. FIG. 5 shows an exemplary user interface 500 provided by the controller 302. The user inputs may be entered or populated in section 502. The user inputs include information related to the linkage type, the bite width, the durability, the capacity, and the number of teeth associated with the bucket to be formed. Further, at step 404, the controller 302 receives a tolerance range associated with the bite width through the input device 304. The tolerance range provides a range of values within which the controller 302 may search for a match for the bucket model based on pre-existing models stored in the system. This information may be entered by the user in section 504 of the user interface 500.

At step 406, the controller 302 searches the database 308 based on the of inputs and the tolerance range provided by the user. It should be noted that the database 308 includes data from multiple data sources. Further, although the database 308 is shown as a single database 308, the database 308 may include a number of data repositories present at the same or different locations. The database 308 stores the bucket related information in generic instance modeling form. Each generic category of the buckets may include multiple instances of buckets having similar properties with different dimensional data. Every bucket to be formed by the controller 302 includes multiple subassemblies each having a number of parts. For example, the bucket may include a top assembly and three or more basic assemblies.

More particularly, the controller 302 searches for a match within the given tolerance range for each of the subassemblies that form the bucket. In one example, the controller 302 may display results of the search, including results that are an exact match for the user defined dimensions of the subassembly in comparison with the prestored bucket models. Further, the controller 302 may also provide results for subassemblies that may not be exact match against the preexisting bucket models, in section 506 of the user interface 500. At step 408, if the exact match is found, the controller 302 reuses one or more parts of the subassembly of the bucket for creating the bucket model. Also, the controller 302 may disable creation of a new part number if the said part already exists in the database 308.

At step 410, if the controller 302 does not find the exact match for any of the subassemblies, the controller 302 displays these results in section 506 of the user interface 500. In such situations, the controller 302 may create the subassembly using a predetermined relationship for the parts of the subassembly that form the bucket model. The predetermined relationship is a correlation of dimensions of parts of the subassembly that lie within or are just outside the tolerance range and the inputs provided by the user. The predetermined relationship is a predefined method of computing dimensions of the new subassembly, by utilizing and appropriately modifying the dimensional data of the pre-existing buckets.

More particularly, the controller 302 is configured to compute an inside bar dimension associated with the bucket model using the predetermined relationship. A person of ordinary skill in the art will appreciate that the bite width of the bucket to be formed is an outside width of all the teeth of the bucket. The inside bar is a distance between inside bars of the bucket. In other words, the controller 302 uses the predetermined relationship to compute the inside bar dimension of the bucket to be formed using the bite width provided by the user and preexisting data entries from the database 308 for building the customized bucket model. The controller 302 generates the subassemblies using the computed inside bar dimension for those subassemblies that do not have exact matches in the pre-existing bucket data. In some embodiments, the user may be prompted by the controller 302 to enter a new part number for the parts of the said subassembly that are generated by the controller 302.

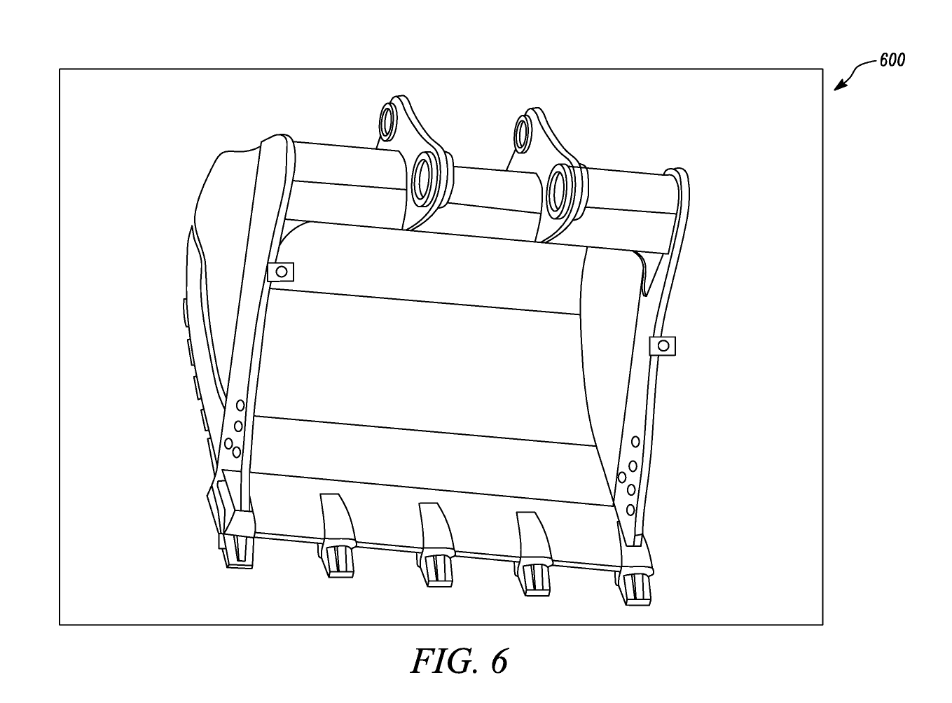

At step 412, the controller 302 generates the bucket model based on the reused parts and the generated parts. The controller 302 generates the bucket model within 3 hours. In some examples, the bucket model is generated within in less than 1 hour. Referring to FIG. 6, an exemplary output of the bucket model for the excavator machine is provided by the controller 302 through user interface 600. It should be noted that the user interfaces 500, 600 provided in the accompanying drawings are exemplary and do not limit the scope of the present disclosure. The bucket model is created by the controller 302 in the CAD software, for example CREO. Additionally or optionally, the controller 302 may identify the generic category that the generated bucket model belongs to. Also, the controller 302 may add an instance of the bucket model in the identified generic category so that the bucket model and subassemblies thereof may be available for reuse. The system and method described above may be utilized by the controller 302 to generate the customized bucket model in CREO for any bucket information provided by the user for buckets of excavator machines.

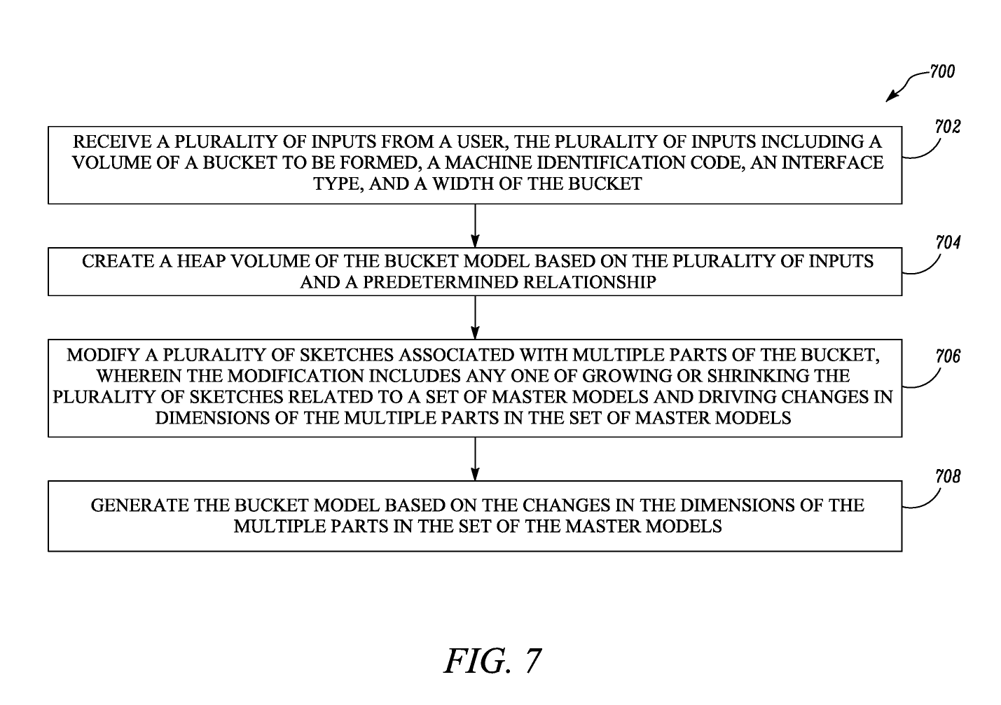

In other embodiments, the control system 300 may utilize another method 700 (see FIG. 7) to create the customized bucket model in CREO within 3 hours. This method 700 may be utilized by the controller 302 for generating the bucket models associated with wheel loader machines and/or draglines. The working of the controller 302 for generating the bucket model for these machines will now be explained in detail in connection with FIGS. 7, 8 and 9.

Referring to FIG. 7, at step 702, the controller 302 receives a number of inputs from the user through the input device 304. The inputs include a volume of the bucket to be formed, a machine identification code, an interface type, and a width of the bucket to be formed. These inputs may be provided by the user through a suitable prompt on a user interface provided by the controller 302. Alternatively, the user may enter the inputs in a file that may be read by the controller 302 for populating the required fields in the user interface. Alternatively, the user may provide these inputs using any other known method.

The controller 302 may then check or determine if the inputs provided by the user are indicative of a bucket model that has previously been created and stored in the system. The controller 302 may access a dataset that is stored in the database 308. The dataset includes prestored bucket models and correlated bucket information, such as dimensional information, part number, and so on. Based on the inputs provided by the user, the controller 302 searches for a match in the dataset. If the match is not found, the controller 302 automatically generates the bucket model in line with the steps described in this section.

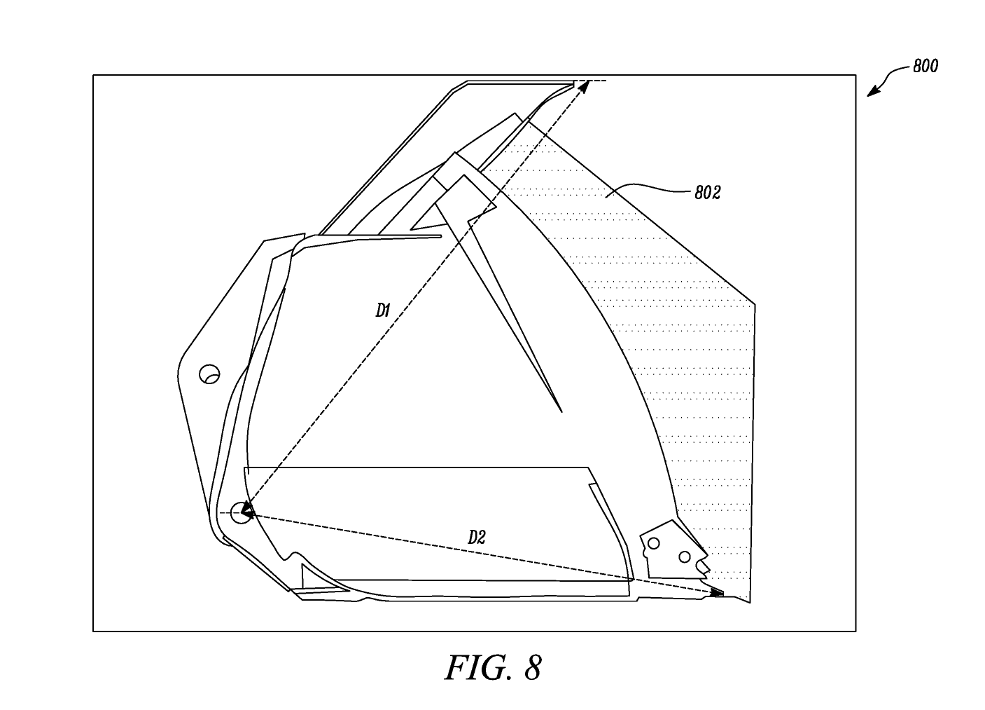

At step 704, the controller 302 creates a heap volume 802 (see user interface 800 in FIG. 8) of the bucket model to be formed based on the inputs provided by the user and a predetermined relationship. The predetermined relationship is a prefixed ratio between a first distance D1 from a pin of the bucket to a top most point on a front face of the bucket, and a second distance D2 from the pin to a front most point on the front face of the bucket. In one example, the prefixed ratio is 1:1. In other examples, the prefixed ratio may vary.

At step 706, the controller 302 retrieves a number of sketches associated with the bucket model from the database 308. The sketches are associated with a set of master models of the bucket. The controller 302 modifies the sketches associated with multiple parts of the bucket. The modification includes either growing or shrinking the sketches related to a set of master models. The set of master models are indicative of a given application type of the bucket. For example, one set of master models may be related to material handling applications. Other set of master models may be created for different applications including for example, general purpose, rock, hard rock, coal, and so on. Each of the set of master models may include prestored CREO bucket models for different machine types, bucket types, and interface types.

Based on the inputs provided by the user, the given set of master models either grow or shrink, that is, the sketches of the bucket models are change by the controller 302 to regenerate the bucket model to a capacity that takes reference from the heap volume 802. For example, based on the inputs provided by the user the heap volume 802 may grow to maintain the predetermined relationship between the first and second distances D1, D2. Alternatively, based on the inputs provided by the user, the heap volume 802 may shrink to maintain the predetermined relationship between the first and second distances D1, D2.

The change in the sketches made by the controller 302 automatically drive changes in dimensions of the multiple parts in the set of master models, creating a new part for the customized bucket model. The sketches on the heap volume 802 are connected to the individual parts of the bucket, causing the bucket to be regenerated by the controller 302 to the new capacity. Further, the controller 302 may additionally modify the bucket model based on the machine identification code and the interface type. For example, based on the interface type a suitable interface may be attached to the bucket model. Different types of interface arrangement models in CREO may be stored in the database 308. The controller 302 may retrieve and update the bucket model with the appropriate interface type based on the user input. In some embodiments, the controller 302 may access and search the database 308 for reuse of some parts to form the bucket model based on dimensions of the bucket and/or the inputs provided by the user.

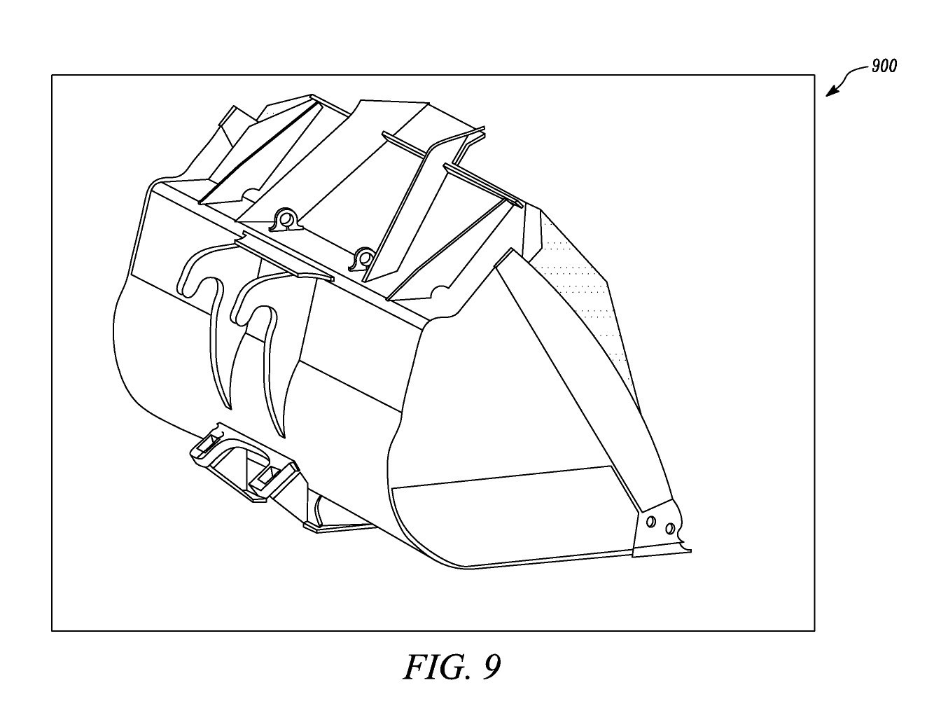

At step 708, the controller 302 generates the bucket model based on the changes in the dimensions of the multiple parts in the set of master models. The bucket model is generated by the controller 302 within 3 hours. The controller 302 may further select and pull a final customized bucket model from the set of regenerated and updated master models. Referring to FIG. 9, an exemplary user interface 900 showing the customized bucket model is provided. Additionally or optionally, the controller 302 may assign a part number to the parts of the bucket model, so that the parts may be stored in the database 308 and reused later based on user request. A person of ordinary skill in the art will appreciate that the user interfaces provided in the accompanying drawings are exemplary and do not limit the scope of the present disclosure. Further, the method 700 described herein may be used by the controller 302 to generate the customized bucket models for wheel loader and/or dragline machines.

The controller 302 may be a microprocessor or other processor as known in the art. The controller 302 may embody a single microprocessor or multiple microprocessors to perform the operations described above. Numerous commercially available microprocessors may be configured to perform the functions of the controller 302. A person of ordinary skill in the art will appreciate that the controller 302 may additionally include other components and may also perform other functions not described herein. Additionally, the control system 300 may be either be contained in a single hardware unit or based on the requirements, separate modules may perform the functionality of the control system 300.

### INDUSTRIAL APPLICABILITY

The present disclosure provides the system for generating the customized bucket model in CREO in less than 3 hours. The methods 200, 400, 700 described herein provide a standardized technique to create the customized bucket models. The methods 200, 400, 700 may ensure that no parts in the inventory have duplicates, avoiding or minimizing any extra costs that may otherwise exist. Further, the system greatly reduces the time in creating the customized bucket. The system provides a seamless tool that allows the user to interact with a single tool to easily create the customized bucket model.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for creating a customized bucket model, the method comprising:
receiving, by a controller, a plurality of inputs from a user, the plurality of inputs associated with the bucket model; and
dynamically generating, by the controller, the bucket model based on the plurality of inputs.

2. The method of claim 1, wherein the bucket model is generated for an excavator.

3. The method of claim 1, wherein the bucket model is generated for a wheel loader or a dragline.

4. The method of claim 1, wherein the bucket model is generated in less than 30 minutes.

5. The method of claim 1, wherein the bucket model is generated in a CAD software.

6. A method for creating a customized bucket model, the method comprising:
receiving, by a controller, a plurality of inputs from a user indicative of linkage type, bite width, durability, capacity, and number of teeth associated with a bucket;
receiving, by a controller, a tolerance range associated with the bite width;
searching, by the controller, a plurality of data sources based on the plurality of inputs and the tolerance range;
reusing, by the controller, one or more parts of a subassembly of the bucket for creating the bucket model if a match is found based on the search;
automatically generating, by the controller, one or more parts of a subassembly of the bucket using a predetermined relationship between parts of the subassembly if the match is not found based on the search, wherein the predetermined relationship includes a correlation of dimensions of parts of the subassembly that lie within the tolerance range and the plurality of user inputs; and
generating, by the controller, the bucket model based on the reuse parts and the generated parts.

7. The method of claim 6, wherein the bucket model is generated for an excavator.

8. The method of claim 6 further comprising:
merging, by the controller, data associated with a number of buckets from a plurality of data sources, the data including dimensional data and part numbers associated with the buckets.

9. The method of claim 6 further comprising:
identifying, by the controller, a generic category of the bucket model; and
adding, by the controller, an instance of the bucket model in the identified generic category.

10. The method of claim 6 further comprising:
computing, by the controller, an inside bar dimension of the bucket model based on the predetermined relationship.

11. The method of claim 6, wherein the bucket model is generated in a CAD software.

12. A method for creating a customized bucket model, the method comprising:
receiving, by a controller, a plurality of inputs from a user, the plurality of inputs including a volume of a bucket to be formed, a machine identification code, an interface type, and a width of the bucket;
creating, by the controller, a heap volume of the bucket model based on the plurality of inputs and a predetermined relationship;
modifying, by the controller, a plurality of sketches associated with multiple parts of the bucket, wherein the modification includes any one of growing or shrinking the plurality of sketches related to a set of master models and driving changes in dimensions of the multiple parts in the set of master models; and
generating, by the controller, the bucket model based on the changes in the dimensions of the multiple parts in the set of the master models.

13. The method of claim 12, wherein the bucket model is generated for any one of a wheel loader or a dragline.

14. The method of claim 12, wherein the predetermined relationship is based on prefixed ratio between a first distance from a pin of the bucket to a top most point on a front face of the bucket, and a second distance from the pin to a front most point on the front face of the bucket.

15. The method of claim 12 further comprising:
searching, by the controller, for a match in a dataset including a plurality of models, based on the plurality of inputs, wherein the controller is configured to automatically generate the bucket model if the match is not found.

16. The method of claim 12 further comprising:
modifying, by the controller, the bucket model based on the machine identification code and the interface type.

17. The method of claim 12 further comprising:
pulling, by the controller, the bucket model from the set of master models for generating the bucket model; and
assigning, by the controller, a part number to each of the parts of the bucket model.

18. The method of claim 12 further comprising:
searching, by the controller, a plurality of databases for one or more parts for reuse based on dimensions of the parts.

19. The method of claim 12, wherein the set of master models is related to a single application type of the bucket.

20. The method of claim 12, wherein the bucket model is generated in a CAD software.
